(19) United States
(12) Patent Application Publication
(10) Pub. No.: US 2026/0011235 A1
(43) Pub. Date: Jan. 8, 2026

(54) POWER MONITOR APPARATUS AND METHOD OF OPERATING A POWER MONITOR APPARATUS

(71) Applicant: LITE-ON TECHNOLOGY CORPORATION, TAIPEI CITY (TW)

(72) Inventor: Yi Tung LIANG, Taipei City (TW)

(21) Appl. No.: 19/093,604

(22) Filed: Mar. 28, 2025

Related U.S. Application Data
(60) Provisional application No. 63/667,860, filed on Jul. 5, 2024.

(51) Int. Cl. G08B 21/18

(52) U.S. Cl. CPC G08B 21/18

(57) ABSTRACT

A power monitor apparatus including power meters and an edge controller is provided. The power meters are configured to generate a plurality of power profiles associated with a plurality of power loops. The edge controller includes a memory and a processor. The processor is configured to move the power profiles into a normal state array and store them as normal process power profiles (NPPPs); compare each NPPP with a first criterion at a first polling rate; identify an alert state subset from the NPPPs that meet the first criterion; move the alert state subset into an alert state array and stored as alert process power profiles (APPPs); compare each APPP with a second criterion at a second polling rate higher than the first polling rate; identify an alarm state subset that meet the second criterion and trigger an alarm event associated with the alarm state subset.

### CROSS REFERENCE TO RELATED APPLICATIONS

This application claims the benefit of U.S. Provisional Application No. 63/667,860, filed Jul. 5, 2024, the entirety of which is incorporated by reference herein.

### BACKGROUND OF THE INVENTION

### Field of the Invention

The present invention relates to an apparatus and a method of power monitoring, and, in particular, to power monitoring and alarm reporting associated with edge controllers.

### Description of the Related Art

Smart home network systems have become popular as the technology of artificial intelligence and the Internet of Things (IoT) has developed. As home appliances become more and more diverse, home safety alert systems are becoming increasingly important. However, common alert systems today usually focus on protecting people, for example, by detecting indoor images with a camera or using a physical button to trigger an alarm when a person indoors finds something abnormal. As a result, not much attention is paid to the surrounding environment, which may result in safety hazards hidden in the surrounding environment not being discovered promptly.

### BRIEF SUMMARY OF THE INVENTION

An embodiment of the present invention provides a power monitor apparatus, comprising a plurality of power meters and an edge controller. The power meters are configured to generate a plurality of power profiles associated with a plurality of power loops. The edge controller comprises a memory and a processor. The processor is configured to initialize on the memory with a first memory space for a normal state process and a second memory space for an alert state process. The processor is configured to move the power profiles into a normal state array of the first memory space, wherein the power profiles are stored as normal process power profiles. The processor is configured to use the normal state process to compare each of the normal process power profiles stored in the normal state array with a first criterion at a first polling rate.

The processor is further configured to use the normal state process to identify an alert state subset from the normal process power profiles that meet the first criterion from the normal state array. The processor is further configured to move the alert state subset into an alert state array stored in the second memory space, wherein the power profiles in the alert state subset are stored as alert process power profiles. The processor is further configured to use the alert state process to compare each alert process power profile stored in the alert state array with a second criterion at a second polling rate. The second polling rate is higher than the first polling rate. The processor is further configured to use the alert state process to identify an alarm state subset from the alert process power profiles that meet the second criterion from the alert state array. The processor is further configured to trigger an alarm event associated with the alarm state subset.

In an embodiment of the present invention, the processor is further configured to identify a plurality of normal state power loops from the power loops based on the normal state array. The processor is further configured to instruct the power meters to monitor the normal state power loops at the first polling rate to continuously generate a plurality of normal state power profiles (NSPP). The processor is further configured to continuously move the normal state power profiles into the normal state array, wherein the normal state power profiles are stored as a first portion of the normal process power profiles. The processor is further configured to continuously compare the normal process power profiles with the first criterion at the first polling rate.

In addition, an embodiment of the present invention provides a method of operating a power monitor apparatus. The method comprises generating a plurality of power profiles associated with a plurality of power loops, by a plurality of power meters. The method comprises initializing on a memory with a first memory space for a normal state process and a second memory space for an alert state process. The method comprises moving the power profiles into a normal state array of the first memory space, wherein the power profiles are stored as normal process power profiles. The method comprises using the normal state process to compare each normal process power profile stored in the normal state array with a first criterion at a first polling rate.

The method further comprises using the normal state process to identify an alert state subset from the normal process power profiles that meet the first criterion from the normal state array. The method further comprises moving the alert state subset into an alert state array stored in the second memory space, wherein the power profiles in the alert state subset are stored as alert process power profiles. The method further comprises using the alert state process to compare each alert process power profile stored in the alert state array with a second criterion at a second polling rate that is higher than the first polling rate. The method further comprises using the alert state process to identify an alarm state subset from the alert process power profiles that meet the second criterion from the alert state array. The method further comprises triggering an alarm event associated with the alarm state subset.

The first criterion is whether the first power consumption values of the normal state power profiles are higher than the threshold power consumption, and the second criterion is whether the second power consumption values of the alert state power loops are higher than the maximum power consumption or whether a short circuit event has occurred based on the second power consumption values of the alert state power loops.

### BRIEF DESCRIPTION OF THE DRAWINGS

The present invention can be more fully understood by reading the subsequent detailed description and examples with references made to the accompanying drawings, wherein:

FIG. 1 illustrates a power monitor apparatus according to embodiments of the present invention;

FIGS. 2A to 2D illustrate a method of operating the power monitor apparatus according to embodiments of the present invention; and

FIG. 3 illustrates a diagram of a total supply current of a plurality of power loops monitored by the power monitor apparatus according to embodiments of the present invention.

### DETAILED DESCRIPTION OF THE INVENTION

The following description is made for the purpose of illustrating the general principles of the invention and should not be taken in a limiting sense. The scope of the invention is best determined by reference to the appended claims.

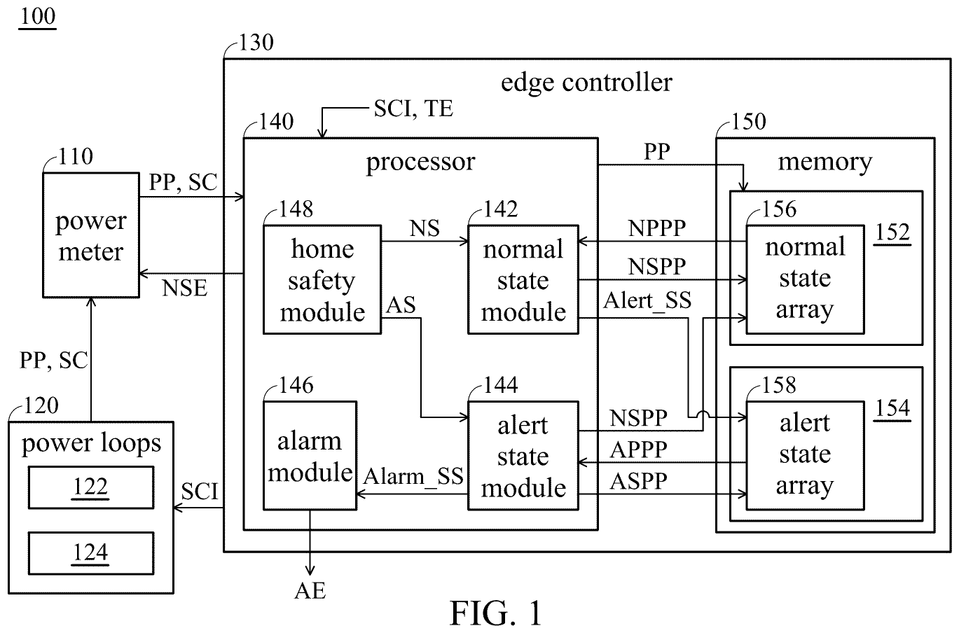

FIG. 1 illustrates a power monitor apparatus 100 according to embodiments of the present invention. The power monitor apparatus 100 includes a plurality of power meters 110, a plurality of power loops 120, and an edge controller 130. The power meters 110 are connected between the power loops 120 and the edge controller 130 through, e.g., transmission lines. By monitoring the power loops 120, the power meters 110 generate a plurality of power profiles PP associated with the power loops 120 and transmit the power profiles PP to the edge controller 130. For example, the power profiles PP may include the identification, current, voltage, or other parameters of each of the power loops 120. That is, each of the power profiles PP corresponds with one of the power loops 120, and thus allowing the edge controller 130 to track or monitor each of the power loops 120.

Edge Controller 130 includes a processor 140 and a memory 150. Processor 140 includes a plurality of modules for various operations, e.g., a normal state module 142, an alert state module 144, an alarm module 146, and a home safety module 148. When the edge controller 130 generates and sends a timer event TE to the processor 140, the home safety module 148 of the processor 140 outputs a normal state signal NS to the normal state module 142 to trigger a normal state process, or outputs an alert state signal AS to the alert state module 144 to trigger an alert state process. Then, processor 140 moves the power profiles PP received from the power meters 110 to memory 150 and stores the power profiles PP as normal process power profiles NPPP.

Specifically, the edge controller 130 generates and sends the timer event TE (e.g., using at least one timer) to trigger the processor 140 to perform polling interval modification. If a power loop enters the normal state, its polling interval is modified to be longer. If a power loop enters the alert state, the polling interval is modified to be shorter. Additionally, the edge controller 130 configures different wake-up times for the timer based on the polling intervals of each power loop. Once the timer is triggered and generates the timer event TE, the processor 140 collects data from the corresponding power loop upon receiving the timer event TE.

Memory 150 includes a first memory space 152 and a second memory space 154, in which the first memory space 152 and the second memory space 154 are independent and contiguous memory spaces that ensures processor 140 may execute the normal and alert process independently. Processor 140 initializes the first memory space 152 and the second memory space 154 for the normal and alert state processes, respectively. Then, processor 140 moves the power profiles PP to the first memory space 152 and stores the power profiles PP as the normal process power profiles NPPP in a normal state array 156.

The normal state process and the alert state process can operate independently without interfering with each other, ensuring execution efficiency. For example, the home safety module 148 of the processor 140 can, in response to the timer event TE, output a normal state signal NS to trigger the normal state process, or output an alert state signal AS to trigger the alert state process. Upon receiving the timer event TE, both the normal and alert state processes are immediately triggered to perform their respective procedures.

Both buffers (first memory space 152 and second memory space 154) are reserved with a predefined capacity to handle their respective events. Pre-reserving memory allows for straightforward code implementation, whereas not reserving memory would require dynamically allocating and deallocating memory as needed, which adds complexity.

The normal and alert processes operate independently without interference, which ensures execution efficiency. The edge controller 130 may monitor a large number of meters, some of which may have events while others do not. If all events were handled in a single process queue, it would require time division (due to different polling rates) and sequential execution based on different processing logics. This would cause events with issues to delay those without, and vice versa, leading to overall poorer performance.

The normal state module 142 of processor 140 compares the normal process power profiles NPPP with a first criterion at a first polling rate by the normal state process to identify an alert state subset Alert_SS from the normal process power profiles NPPP. For example, the first criterion is whether the power consumption values of the normal process power profiles NPPP are higher than a threshold power consumption NV.

When one or more of the normal process power profiles NPPP meet the first criterion, processor 140 identifies these normal process power profiles NPPP as the alert state subset Alert_SS and stores it into an alert state array 158, in which the power profiles in the alert state subset Alert_SS are stored as alert process power profiles APPP. The alert state module 144 compares the alert process power profiles APPP with a second criterion at a second polling rate that is higher than the first polling rate using the alert state process to identify an alarm state subset Alarm_SS from the alert process power profiles APPP. For example, the second criterion is whether the power consumption values of the alert process power profiles APPP are higher than the maximum power consumption MV.

When one or more of the alert process power profiles APPP meet the second criterion, processor 140 identifies these alert process power profiles APPP as the alarm state subset Alarm_SS and triggers an alarm event AE associated with the alarm state subset Alarm_SS. For example, the alarm event AE may indicate the users that a power overload has happened through application notifications, or report to the public safety answering point (PSAP) to deal with safety hazards, e.g., caused by power overload in the house.

In the operation of comparing the normal process power profiles NPPP with the first criterion by the normal state process, when the normal process power profiles NPPP do not meet the first criterion, i.e., when the power consumption values of the normal process power profiles NPPP is lower than the threshold power consumption NV, the normal state module 142 identifies a plurality of normal state power loops 122 from the power loops 120 according to the identification of each of the power loops 120. Then, the edge controller 130 reports a normal state event NSE and instructs the power meters 110 to monitor the normal state power loops 122 at the first polling rate continuously to generate a plurality of normal state power profiles NSPP. The normal state module 142 receives and moves the normal state power profiles NSPP into the normal state array 156, in which the normal state power profiles NSPP are stored as a first portion of the normal process power profiles NPPP.

In the operation of comparing the alert process power profiles APPP with the second criterion by the alert state process, when the alert process power profiles APPP do not meet the second criterion, i.e., when the power consumption values of the alert process power profiles APPP is not higher than the maximum power consumption MV, the alert state module 144 identifies a plurality of alert state power loops 124 from the power loops 120 according to the identification of each of the power loops 120. Then, the edge controller 130 instructs the power meters 110 to continue monitoring the alert state power loops 124 at the second polling rate to generate a plurality of alert state power profiles ASPP. The alert state module 144 receives and moves the alert state power profiles ASPP into the alert state array 158, in which the alert state power profiles ASPP are stored as a first portion of the alert process power profiles APPP.

The alert state module 144 continues to compare the refreshed alert process power profiles APPP (i.e., the alert process power profiles APPP that includes the alert state power profiles ASPP) with the second criterion at the second polling rate, and the power meters 110 continues to monitor the alert state power loops 124 at the second polling rate. When the power consumption values of a first portion of the alert state power loops 124 are lower than the threshold power consumption NV, the alert state module 144 identifies the first portion of the alert state power loops 124 as the normal state power loops 122 based on the corresponding alert state power profiles ASPP. Then, the alert state module 144 identifies the corresponding alert state power profiles ASPP as the normal state power profiles NSPP. These normal state power profiles NSPP identified by the alert state module 144 are moved to the normal state array 156 and are stored as a second portion of the normal process power profiles NPPP.

Through the interactions of the normal state module 142, the alert state module 144, memory 150, and the power meters 110, the edge controller 130 can change the polling rate (e.g., between the first and second polling rates) by comparing the power profiles PP with different criterion (e.g., the first or second criterion) and power consumption (e.g., the threshold power consumption NV or the maximum power consumption MV) to flexibly monitors the power loops 120 according to different conditions. Tracking at a relatively slow rate (e.g., at the first polling rate) when the power loops 120 have lower power consumption may save power and memory spaces for storing and monitoring data and/or information of the power loops 120. Additionally, when the power consumption of the power loops 120 drops to lower than the threshold power consumption NV, the edge controller 130 can report a normal state event NSE to change (e.g., slow down) the polling rate of the power meters 110.

Further, when the power consumption values of the power profiles PP are high (e.g., over the threshold power consumption NV), it indicates that the power loops 120 corresponding to these power profiles PP may have a chance to cause hazards in the surrounding environment. Therefore, the edge controller 130 may instruct the power meters 110 to monitor at a higher rate (e.g., the second polling rate) to detect a hazard, e.g., the power consumption exceeds the maximum power consumption MV, in time, triggers an associated alarm event AE, and reports to the public safety answering point (PSAP) or the users. Additionally, a higher polling rate allows the edge controller 130 to switch the power meters 110 back to the lower rate more quickly if the power consumption of the power loops PP drops to lower than the threshold power consumption NV.

As described above, when a portion of the alert process power profiles APPP meets the second criterion (i.e., the power consumption values exceed the maximum power consumption MV), an alarm state subset Alarm_SS is identified and transmitted to the alarm module 146 to trigger the alarm event AE. However, some other conditions and events may also trigger the alarm event. For example, when the power consumption values of the power loops 120 remain at values that are over the maximum power consumption for some time, a short circuit SC may happen. The power meters 110 then detect and transmit the short circuit SC to the edge controller 130 to trigger the alarm event AE. Further, the edge controller 130 can also generate a short circuit interruption SCI to create a short circuit event in the power loops 120 and trigger the alarm event AE.

After the alarm event AE is triggered, the edge controller 130 can report to the PSAP actively or passively through link layer discovery protocol media endpoint devices (LLDP-MED) that support emergency call service (ECS) functions, or by being voice over internet protocol (VOIP) equipment.

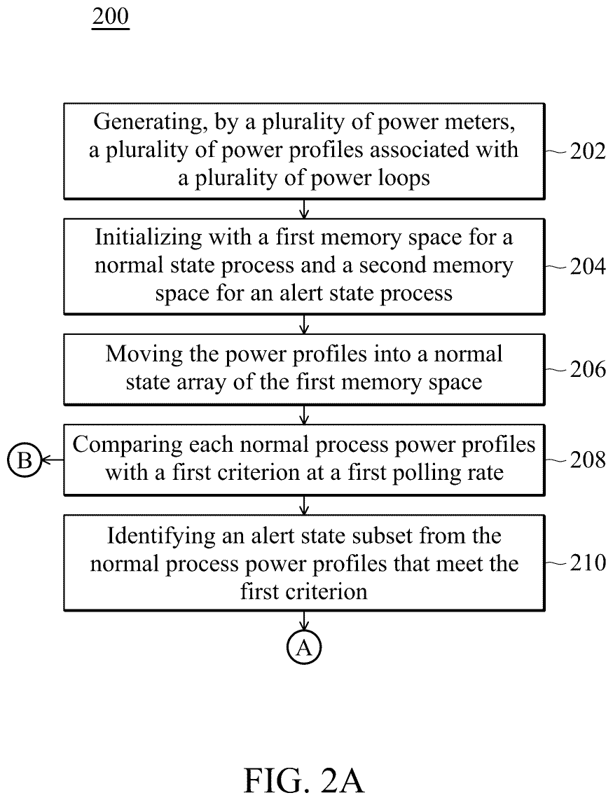

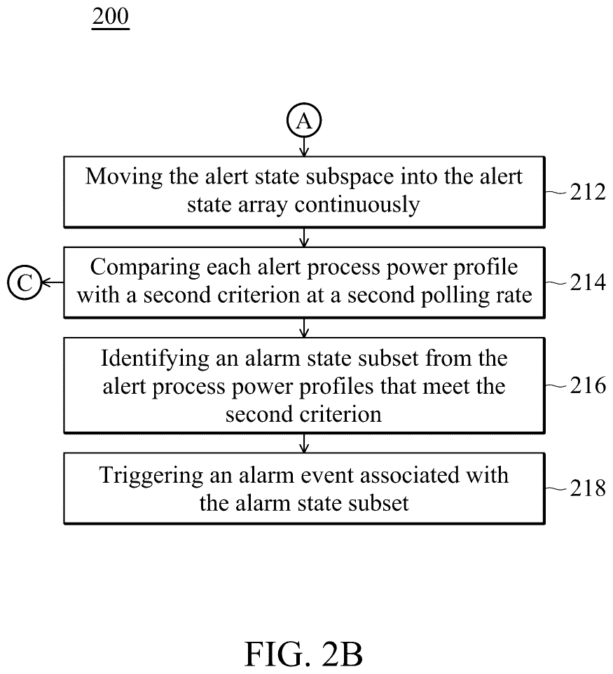

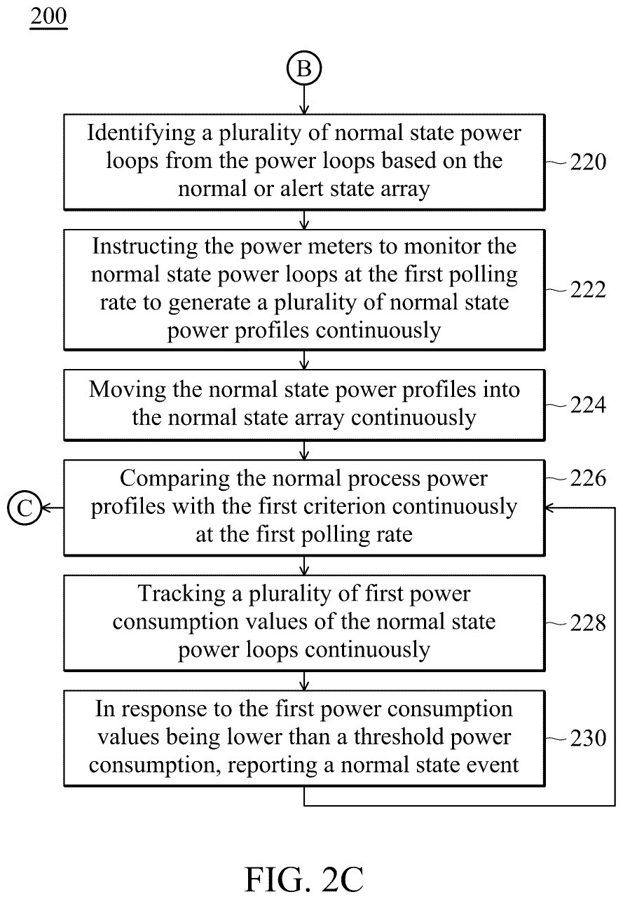

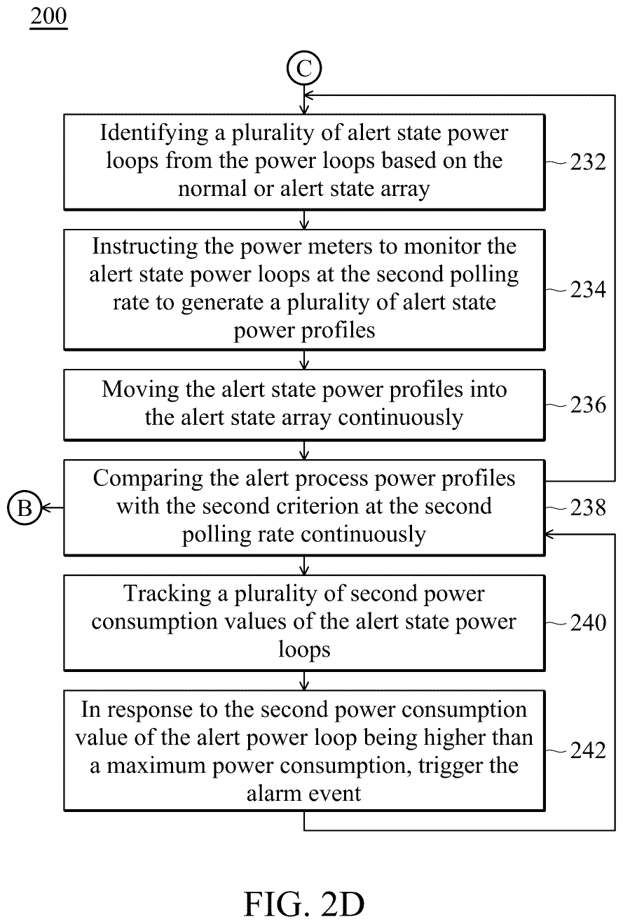

FIGS. 2A to 2D illustrate a method 200 of operating the power monitor apparatus 100 of FIG. 1, according to embodiments of the present invention. In step 202, when the power loops 120 starts to operate, the edge controller 130 instructs the power meters 110 to monitor the power loops 120 at the first polling rate to generate the power profiles PP. In step 204, processor 140 of the edge controller 130 initializes the first memory space 152 and the second memory space 154 in memory 150 for the normal and alert state processes, respectively. In step 206, the power profiles PP are moved from the power meters 110 into the normal state array 156 and are stored as the normal process power profiles NPPP in the first memory space 152.

In step 208, the edge controller 130 generates the timer event TE and triggers the home safety module 148 of processor 140 to generate the normal state signal NS and the alert state signal AS. Then, the normal state module 142 and the alert state module 144 are activated. Thereby, the normal state module 142 starts to compare the normal process power profiles NPPP with the first criterion, i.e., whether the power consumption values of the normal process power profiles NPPP are higher than the threshold power consumption NV, at the first polling rate that is relatively slow.

In response to the power consumption values of a first portion of the normal process power profiles NPPP meets the first criterion, the method 200 continues to step 210, and the edge controller 130 identifies the first portion of the normal process power profiles NPPP as the alert state subset Alert_SS and identifies the corresponding power loops 120 as a first portion of the alert state power loops 124. Then, the method 200 proceeds to node A (FIG. 2B). In step 212, the normal state module 142 moves the alert state subset Alert_SS into the alert state array 158 and stores the alert state subset Alert_SS as the alert process power profiles APPP. In step 214, the alert state module 144 compares the alert process power profiles APPP with the second criterion, i.e., whether the power consumption values of the alert process power profiles APPP are higher than the maximum power consumption MV, at the second polling rate that is relatively fast.

In response to a first portion of the alert process power profiles APPP meets the second criterion, the method 200 proceeds to step 216, and the alert state module 144 identifies the first portion of the alert process power profiles APPP as the alarm state subset Alarm_SS. Then, in step 218, the alert state module 144 transmits the alarm state subset Alarm_SS to the alarm module 146 and triggers the alarm event AE associated with the alarm state subset Alarm_SS (and/or the power loops 120 corresponding to the alarm state subset Alarm_SS).

In step 208, in response to a second portion of the normal process power profiles NPPP does not meet the first criterion, i.e., their power consumption values are lower than the threshold power consumption NV, the method 200 proceeds to node B (FIG. 2C). In step 220, the normal state module 142 identifies the normal state power loops 122 from the power loops 120 based on the second portion of the normal process power profiles NPPP that are stored in the normal state array 156. Then, in step 222, the edge controller 130 instructs the power meters 110 to monitor the normal state power loops 122 at the first polling rate to generate the normal state power profiles NSPP. In step 224, the edge controller 130 receives and moves the normal state power profiles NSPP into the normal state array 156, in which the normal state power profiles NSPP are stored as a third portion of the normal process power profiles NPPP.

In steps 226 and 228, the normal state module 142 continues to compare the normal process power profiles NPPP with the first criterion at the first polling rate, and the power meters 110 continuously track the power consumption values of the normal state power loops 122. In step 230, in response to the power consumption values of the normal state power loops 122 being lower than the threshold power consumption NV, the edge controller 130 generates and reports the normal state event NSE. Then, the method 200 goes back to step 226 and repeats steps 226, 228, and 230 until the normal process power profiles NPPP meet the first criterion.

For example, the normal state event NSE may be output to the power meters 110 to instruct the power meters 110 to monitor the normal state power loops 122 continuously at the first polling rate. The normal state event NSE may also be utilized to change the polling rate of the power meters 110, or to notify the users that the power loops 120 are in a normal state through application notifications.

In step 214, in response to a second portion of the alert process power profiles APPP meets the first criterion but does not meet the second criterion, i.e., their power consumption values are not lower than the threshold power consumption NV but are lower than the maximum power consumption MV, the method 200 proceeds to node C (FIG. 2D). Similarly, in step 226, in response to a fourth portion of the normal process power profiles NPPP meet the first criterion, the method 200 proceeds to node C.

In step 232, the alert state power loops 124 are identified from the power loops 120 based on the normal state array 156 and the alert state array 158. In step 234, the edge controller 130 instructs the power meters 110 to monitor the alert state power loops 124 at the second polling rate to generate the alert state power profiles ASPP. The alert state module 144 moves the alert state power profiles ASPP into the alert state array 158 in step 236 (or in the case of the normal state module 142, moving the alert state subset Alert_SS into the alert state array 158).

Then, in steps 238 and 240, the power meters 110 tracks the power consumption values of the alert state power loops 124 from step 232, and the alert state module 144 compares the alert process power profiles APPP with the second criterion at the second polling rate. In response to a third portion of the alert process power profiles APPP does not meet the second criterion (i.e., power consumption values are lower than the maximum power consumption MV), the alert state module 144 compares the third portion of the alert process power profiles APPP with the first criterion at the second polling rate. If the third portion of the alert process power profiles APPP does not meet the first criterion (i.e., power consumption values are lower than the threshold power consumption NV), the method 200 goes back to node B and enters step 220.

If the third portion of the alert process power profiles APPP meets the first criterion but does not meet the second criterion, the method 200 goes back to node C and enters step 232 to identify the alert state power loops 124 from the power loops 120 based on the third portion of the alert process power profiles APPP. If the third portion of the alert process power profiles APPP meets the second criterion, in step 242, the alert state module 144 identifies and transmits the alarm state subset Alarm_SS to the alarm module and triggers the alarm event AE. Then, the method 200 goes back to step 238 and compares the alert process power profiles APPP with the second criterion at the second polling rate.

It should be noted that some of the steps of the method 200 can be performed simultaneously. For example, when the normal state module 142 compares the normal process power profiles NPPP with the first criterion (e.g., in steps 208 and 226), the alert state module 144 may compare the alert process power profiles APPP with the second criterion simultaneously (e.g., in steps 214 and 238). Additionally, when the alarm event AE corresponding to the alarm state subset Alarm_SS is triggered (e.g., in steps 218 and 242), the normal state event NSE corresponding to the normal state power loops 122 may be generated simultaneously (e.g., in step 230).

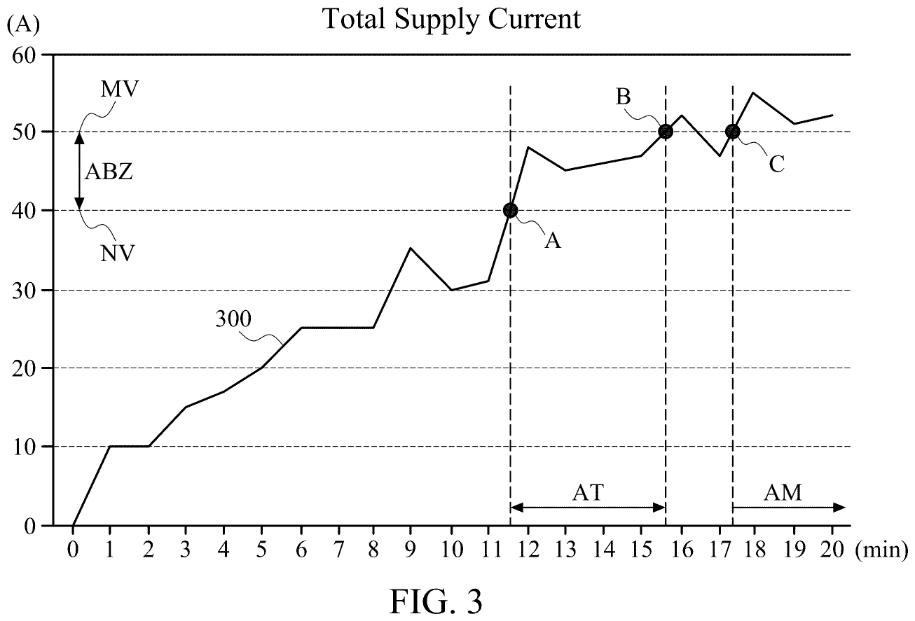

FIG. 3 illustrates a diagram of the total supply current of power loops 120 monitored by the power monitor apparatus 100 according to embodiments of the present invention, in which a line 300 represents the total supply current of power loops 120. Regarding FIG. 3, the horizontal axis represents the operating time of power loops 120 (or the monitoring time of the power meters 110), and the vertical axis represents the total supply current on power loops 120. In the embodiment shown in FIG. 3, assume that the first polling rate is to monitor the power loops 120 every 1 minute, and the second polling rate is to monitor the power loops 120 every 0.5 minutes.

Before the operating time reaches about 11.5 minutes, the total supply current of the power loops 120 is lower than 40 A (e.g., which corresponds to power consumption values lower than the threshold power consumption NV). Therefore, the power profiles PP of the power loops 120 do not meet the first criterion. As a result, the normal state module 142 identifies power loops 120 as the normal state power loops 122. The power meters 110 monitor the normal state power loops 122 at a lower polling rate (e.g., monitors every 1 minute as described above) to generate the normal state power profiles NSPP, and the edge controller 130 generates the normal state event NSE.

When the operating time reaches about 11.5 minutes (i.e., point A as noted in FIG. 3), the total supply current of the power loops 120 reaches 40 A (e.g., which corresponds to the power consumption values being not lower than the threshold power consumption NV). Therefore, at 12 minutes after the initialization of the operation, the normal state module 142 identifies and moves the alert state subset Alert_SS into the alert state array 158, and the alert state module 144 identifies the alert state power loops 124 based on the alert state subset Alert_SS. Additionally, the edge controller 130 instructs the power meters 110 to monitor the alert state power loops 124 at a higher polling rate (e.g., monitors every 0.5 minutes as described above) to generate the alert state power profiles ASPP. When the total supply current exceeds 40 A (i.e., power consumption values are higher than the threshold power consumption NV), define the power consumption values of power loops 120 as inside an alert buffer zone ABZ.

By defining the alert buffer zone ABZ, edge controller 130 identifies the alert state power loops 124 and instructs the power meters to monitor the alert state power loops 124 at a higher polling rate before the alarm event AE is triggered. Thereby, when the power consumption values of the power loops 120 reaches the threshold power consumption NV but are lower than the maximum power consumption MV, the edge controller 130 will not trigger the alarm event AE, and a false alarm is avoided. Besides, by monitoring at a higher polling rate when entering the alert buffer zone ABZ, power meters 110 and the edge controller 130 are more sensitive to the change in the power consumption of the power loops 120, which improves the timing accuracy of triggering or canceling an alarm event AE.

As noted in FIG. 3 with point B, when the power consumption of the power loops 120 is in the alert buffer zone ABZ (which indicates that the power monitor apparatus 100 enters an alert state AT), the edge controller 130 tracks the power consumption values of the alert state power loops 124 every 0.5 minutes. When the operating time reaches about 15.6 minutes (i.e., point B as noted in FIG. 3), the total supply current of the power loops 120 is higher than 60 A, which corresponds to power consumption being not lower than the maximum power consumption MV. Since the total supply current of the power loops 120 at 16 minutes after the initialization of the operation is still higher than 60 A, the alert state module 144 identifies the alarm state subset Alarm_SS. The alarm event AE is triggered when the time reaches 16 minutes (which indicates that the power monitor apparatus 100 enters an alarm state AM).

However, when the operating time reaches about 16.4 minutes, the total supply current drops to lower than 60 A (i.e., the maximum power consumption MV). Therefore, when the operating time reaches 16.5 minutes, the alarm event AE is canceled, and the alarm state subset Alarm_SS is identified as the alert state power profiles ASPP. Since the total supply current is not lower than 40 A (i.e., the threshold power consumption NV), the polling rate of the power meters 110 and the edge controller 130 remains at monitoring/tracking every 0.5 minutes, and the power monitor apparatus 100 is back to the alert state AT.

Next, when the operating time reaches about 17.3 minutes, the total supply current is again higher than 60 A. Therefore, when the operating time reaches 17.5 minutes, the edge controller 130 identifies the alarm state subset Alarm_SS and triggers the associated alarm event AE. Additionally, as shown in FIG. 3, the total supply current of power loops 120 remains higher than 60 A (i.e., higher than the maximum power consumption MV) after the operating time reaches 17.3 minutes. Therefore, the edge controller 130 continues to report the alarm event AE to the public safety answering point or to notify the users through application notifications.

As described above, the power monitor apparatus 100 and the method 200 may be utilized to improve the timing accuracy of triggering an alarm event by modifying the polling rate according to current power consumption values. Additionally, the power monitor apparatus 100 can automatically send the alarm event AE to the PASP or the users through link layer discovery protocol media endpoint discovery (LLPD-MED).

In some embodiments, the threshold and maximum power consumption may also be modified based on parameters such as an estimated power load, tariff information, indoor human activities, etc., to define a more suitable alert buffer zone for the power loops 120. For example, if the estimated power load increases, e.g., due to a change in electricity prices or weather (i.e., which may affect human indoor activity), the threshold power consumption NV may rise.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power monitor apparatus, comprising:
a plurality of power meters, configured to generate a plurality of power profiles associated with a plurality of power loops; and
an edge controller, comprising:
a memory; and
a processor, configured to:
initialize, on the memory with a first memory space for a normal state process and a second memory space for an alert state process;
move the power profiles PP into a normal state array of the first memory space, wherein the power profiles are stored as normal process power profiles;
compare, by the normal state process, each of the normal process power profiles stored in the normal state array with a first criterion at a first polling rate;
identify, by the normal state process, an alert state subset from the normal process power profiles that meet the first criterion from the normal state array;
move the alert state subset into an alert state array stored in the second memory space, wherein the power profiles in the alert state subset are stored as alert process power profiles;
compare, by the alert state process, each alert process power profile stored in the alert state array with a second criterion at a second polling rate that is higher than the first polling rate;
identify, by the alert state process, an alarm state subset from the alert process power profiles that meet the second criterion from the alert state array; and
trigger an alarm event associated with the alarm state subset.

2. The power monitor apparatus as claimed in claim 1, wherein the operation of comparing, by the normal state process, each of the normal process power profiles stored in the normal state array with the first criterion at the first polling rate further comprises:
identifying a plurality of normal state power loops from the power loops based on the normal state array;
instructing the power meters to monitor the normal state power loops at the first polling rate to continuously generate a plurality of normal state power profiles;
moving the normal state power profiles into the normal state array continuously, wherein the normal state power profiles are stored as a first portion of the normal process power profiles; and
comparing the normal process power profiles with the first criterion continuously at the first polling rate.

3. The power monitor apparatus as claimed in claim 2, wherein the operation of comparing, by the normal state process, each normal process power profile stored in the normal state array with the first criterion further comprises:
tracking a plurality of first power consumption values of the normal state power loops based on the normal state power profiles continuously; and
reporting a normal state event and instructing the power meters to continuously monitor the normal state power loops at the first polling rate in response to the first power consumption values being lower than a threshold power consumption.

4. The power monitor apparatus as claimed in claim 3, wherein the first criterion is whether the first power consumption values of the normal state power profiles are higher than the threshold power consumption.

5. The power monitor apparatus as claimed in claim 1, wherein the operation of comparing, by the alert state process, each alert process power profile stored in the alert state array with the second criterion at the second polling rate further comprises:
identifying a plurality of alert state power loops from the power loops based on the alert state array;
instructing the power meters to monitor the alert state power loops at the second polling rate to generate a plurality of alert state power profiles continuously;
moving the alert state power profiles into the alert state array continuously, wherein the alert state power profiles are stored as a first portion of the alert process power profiles; and
comparing the alert process power profiles with the second criterion at the second polling rate continuously.

6. The power monitor apparatus as claimed in claim 5, wherein the operation of comparing, by the alert state process, each alert process power profile stored in the alert state array with the second criterion at the second polling rate further comprises:
tracking a plurality of second power consumption values of the alert state power loops based on the alert state power profiles; and
moving the alert state power profiles of the first portion of the alert state power loops into the normal state array in response to the second power consumption values of a first portion of the alert state power loops being lower than a threshold power consumption.

7. The power monitor apparatus as claimed in claim 5, wherein the operation of comparing, by the alert state process, each alert process power profile stored in the alert state array with the second criterion at the second polling rate further comprises:
tracking a plurality of second power consumption values of the alert state power loops based on the alert state power profiles; and
triggering the alarm event associated with the alarm state subset in response to the second power consumption value of a second portion of the alert power loop being higher than a maximum power consumption.

8. The power monitor apparatus as claimed in claim 7, wherein the second criterion is whether the second power consumption values of the alert state power loops are higher than the maximum power consumption, or whether a short circuit event has occurred based on the second power consumption values of the alert state power loops.

9. The power monitor apparatus as claimed in claim 1, wherein the edge controller is further configured to output the alarm event to a Public Safety Answering Point (PSAP).

10. The power monitor apparatus as claimed in claim 1, wherein the first memory space and the second memory space are fixed, contiguous, and independent from each other such that the normal state process and the alert state process are executed by the processor independently.

11. The power monitor apparatus as claimed in claim 1, wherein the power meters are coupled to the edge controller through transmission lines.

12. The power monitor apparatus as claimed in claim 1, wherein the edge controller is further configured to modulate the second criterion based on an estimated power load inferred based on at least one of tariff information and indoor human activity.

13. The power monitor apparatus as claimed in claim 1, wherein the processor further comprises a home safety module, wherein the home safety module is configured to output a normal state signal to trigger the normal state process, or to output an alert state signal to trigger the alert state process according to a plurality of timer events from the edge controller.

14. The power monitor apparatus as claimed in claim 8, wherein the short circuit event is a short circuit that occurs in the power loops, or a short circuit interruption from the edge controller.

15. The power monitor apparatus as claimed in claim 9, wherein the alarm is further sent to a user through Link Layer Discovery Protocol Media Endpoint Discovery (LLPD-MED).

16. A method of operating a power monitor apparatus, comprising:
using a plurality of power meters to generate a plurality of power profiles associated with a plurality of power loops;
initializing, on a memory, with a first memory space for a normal state process and a second memory space for an alert state process;
moving the power profiles into a normal state array of the first memory space, wherein the power profiles are stored as normal process power profiles;
using the normal state process to compare each normal process power profile stored in the normal state array with a first criterion at a first polling rate;
using the normal state process to identify an alert state subset from the normal process power profiles that meet the first criterion from the normal state array;
moving the alert state subset into an alert state array stored in the second memory space, wherein the power profiles in the alert state subset are stored as alert process power profiles;
using the alert state process to compare each alert process power profile stored in the alert state array with a second criterion at a second polling rate that is higher than the first polling rate;
using the alert state process to identify an alarm state subset from the alert process power profiles that meet the second criterion from the alert state array; and
triggering an alarm event associated with the alarm state subset.

17. The method of operating the power monitor apparatus as claimed in claim 16, wherein the operation of using the normal state process to compare each normal process power profile stored in the normal state array with the first criterion at the first polling rate further comprises:
identifying a plurality of normal state power loops from the power loops based on the normal state array;
instructing the power meters to monitor the normal state power loops at the first polling rate to generate a plurality of normal state power profiles continuously;
moving the normal state power profiles into the normal state array continuously, wherein the normal state power profiles are stored as a first portion of the normal process power profiles;
continuously comparing the normal process power profiles with the first criterion at the first polling rate;
continuously tracking a plurality of first power consumption values of the normal state power loops based on the normal state power profiles; and
reporting a normal state event and instructing the plurality of power meters to keep monitoring the normal state power loops at the first polling rate continuously in response to the first power consumption values being lower than the threshold power consumption.

18. The method of operating the power monitor apparatus as claimed in claim 17, wherein the first criterion is whether the first power consumption values of the normal state power profiles are higher than the threshold power consumption.

19. The method of operating the power monitor apparatus as claimed in claim 16, wherein the operation of comparing, by the alert state process, each alert process power profile stored in the alert state array with the second criterion at the second polling rate further comprises:
identifying a plurality of alert state power loops from the power loops based on the alert state array;
instructing the power meters to monitor the alert state power loops at the second polling rate to generate a plurality of alert state power profiles continuously;
moving the alert state power profiles into the alert state array continuously, wherein the alert state power profiles are stored as a first portion of the alert process power profiles;
continuously comparing the alert process power profiles with the second criterion at the second polling rate;
tracking a plurality of second power consumption values of the alert state power loops based on the alert state power profiles; and
triggering the alarm event associated with the alarm state subset in response to the second power consumption value of the alert power loop being higher than the maximum power consumption.

20. The method of monitoring the electronic system as claimed in claim 19, wherein the second criterion is whether the second power consumption values of the alert state power loops are higher than the maximum power consumption or whether a short circuit event occurs based on the second power consumption values of the alert state power loops.
